(19) United States
(12) Patent Application Publication
(10) Pub. No.: US 2026/0073258 A1
(43) Pub. Date: Mar. 12, 2026

(54) USING MARKOV CHAINS TO EXPLAIN MACHINE LEARNING MODEL PREDICTIONS AND TO EVALUATE AUTONOMOUS COMPUTER AGENTS

(71) Applicant: PAYPAL, INC., San Jose, CA (US)

(72) Inventors: Roy Lothan, Tel Aviv (IL); Matan Marudi, Kiryat Ono (IL); Yotam Dery, Tel Aviv (IL); Yuval Wartelsky, Kiryat Ono (IL)

(21) Appl. No.: 18/883,526

(22) Filed: Sep. 12, 2024

(51) Int. Cl. G06N 5/045; G06N 3/0455

(52) U.S. Cl. CPC G06N 5/045; G06N 3/0455

(57) ABSTRACT

Historical performance information of a plurality of autonomous agents configured to handle a plurality of tasks is accessed. The historical performance information indicates, for each autonomous agent, a successful outcome or a failed outcome for each of the tasks handled by the autonomous agent. A Markov chain comprising a plurality of states is constructed based on the autonomous agents. Each autonomous agent corresponds to a different state of the states. For each autonomous agent, a first score and a second score are calculated based on the Markov chain. The first score corresponds to an expected number of transitions from the autonomous agent to other autonomous agents until the successful outcome or the failed outcome is reached, The second score corresponds to a probability of the autonomous agent ultimately achieving the successful outcome. The autonomous agents are evaluated based on the first score and the second score.

### BACKGROUND

### Field of the Invention

The present application generally relates to machine learning. More particularly, the present application involves constructing Markov chains to explain predictions made by machine learning models and to evaluate the performance of autonomous computerized agents.

### Related Art

Over the past several decades, rapid advances in Integrated Circuit fabrication and wired/wireless telecommunications technologies have brought about the arrival of the information age, in which electronic communications or interactions between various entities are becoming increasingly more common. More recently, operations involving some of these communications and interactions use machine learning, as well as autonomous computerized agents. For example, predictions may be made via a machine learning model to determine whether to process a transaction, share data, deny access to content, and make other decisions associated with electronic communications and interactions, and autonomous computerized agents may be used to provide customer support and/or perform diagnostics in place or in addition to conventional human agents. Unfortunately, existing systems and methods have not been able to provide sufficient insight into the predictions made by the machine learning models or accurate evaluations of the autonomous computerized agents. As such, although existing machine learning systems and methods have been generally adequate for their intended purposes, they have not been entirely satisfactory in certain aspects.

### BRIEF DESCRIPTION OF THE FIGURES

FIG. 1 is a block diagram of a networked system according to various aspects of the present disclosure.

FIG. 2 is a block diagram of a process flow of generating a machine learning model prediction and producing an explanation for the prediction according to various aspects of the present disclosure.

FIG. 3 illustrates a block diagram of a Markov chain for evaluating the performance of autonomous computerized agents according to various aspects of the present disclosure.

FIG. 4 is a flowchart illustrating a method of generating an explanation for a machine learning prediction according to various aspects of the present disclosure.

FIG. 5 is a flowchart illustrating a method of using a Markov chain to evaluate autonomous computerized agents according to various aspects of the present disclosure.

FIG. 6 illustrates an example artificial neural network according to various aspects of the present disclosure.

FIG. 7 is a simplified example of a cloud-based computing architecture according to various aspects of the present disclosure.

FIG. 8 is an example computer system according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

The present disclosure pertains to using Markov chains to generate clear explanations for predictions made by machine learning models, as well as to make more accurate and objective evaluations regarding the performance and/or capability of autonomous computerized agents. In more detail, the use of machine learning to make predictions has gained popularity in recent years. For example, machine learning can be used to detect fraud, perform medical diagnosis, forecast trends, anticipate user behaviors, optimize process flows, etc. However, in many contemporary machine learning applications, the interpretability of machine learning predictions remains a significant concern. Current practices often rely on overly simplistic methods of feature importance assessment within the machine learning models (e.g., Random Forest, XGBoost). However, these methods often fall short in offering comprehensive insights into the decision-making process of the model, particularly in scenarios where complex interactions between the features influence the machine learning predictions. Moreover, existing methods and systems may not fully capture the sequential relationships and dependencies between the features in a machine learning model's decision pathways. Consequently, there exists a need for more robust and holistic approaches to enhance the explainability of predictions generated by machine learning models, particularly in domains where transparency and interpretability are paramount for user trust and regulatory compliance.

Another shortcoming of existing systems and methods pertains to the evaluation of the performance of autonomous computerized agents. In more detail, autonomous computerized agents may be built on certain types of machine learning models, such as a Large Language Model (LLM). The autonomous computerized agents may also be specialized in various domains, such as customer support, data query, or technical assistance. However, the current systems and methods used to evaluate the performance of these autonomous computerized agents often lack the sophistication needed to capture the complexities of multi-agent interactions. Current methods typically rely on simplistic metrics like success rates or failure counts for individual agents, without considering the intricacies of collaborative request resolution involving multiple autonomous computerized agents. For example, in dynamic environments where requests may traverse through several autonomous computerized agents before successful resolution, traditional scoring mechanisms for evaluating the autonomous computerized agents may fail to provide a comprehensive assessment of each agent's effectiveness. Without being able accurately assess an agent's effectiveness, inaccuracies or inefficiencies may persist, resulting in degraded interactions or more extensive computing resources to fully address an issue. Consequently, there is a need for an evaluation scheme that can accurately measure the contribution of each autonomous computerized agent to the overall success of request resolution, for example, by taking into account the collaborative nature of the routing process.

The present disclosure addresses the machine learning prediction explainability issue through the integration of Markov chains. For example, Markov chains may comprise probabilistic models representing sequences of events. By incorporating the Markov chains into machine learning techniques such as Random Forests or XGBoost, interpretability of the predictions made by these machine learning techniques may be significantly improved, and valuable insights into the feature importance and model behavior may be revealed. For example, a machine learning model is accessed, where the machine learning model is trained based on a plurality of data features. Based on the machine learning model, an importance of the plurality of data features is estimated, which may involve a ranking of the importance of each data feature based on an importance score. Thereafter, a Markov chain is constructed based on the estimated importance of the data features. In some embodiments, the estimated importance of each data feature corresponds to a different state in the Markov chain. When a prediction is generated by the machine learning model, a traversal of the Markov chain may be used to produce an explanation of the prediction. Such an explanation may be visualized in various forms, such as feature importance plots, decision trees, or interactive dashboards. Users can interactively explore the contributions of different features to model predictions, thereby gaining valuable insights into the machine learning model behavior.

The present disclosure also utilizes Markov chains to address the issue of evaluating the performance of autonomous computerized agents. For example, the historical performance information of a plurality of autonomous computerized agents is obtained. The autonomous computerized agents are configured to handle a plurality of tasks, such as providing customer support or running a diagnostic in a specific field or sub-field. The historical performance information indicates, for each of the autonomous computerized agents, a successful outcome or a failed outcome for each task handled by the autonomous computerized agent. A Markov chain is then constructed based on the plurality of autonomous agents. The Markov chain comprises a plurality of states, and each of the autonomous computerized agents corresponds to a different state. For each autonomous computerized agent, a first score and a second score are calculated based on the Markov chain. The first score corresponds to an expected number of transitions from the autonomous computerized agent to other autonomous computerized agents until the successful outcome or the failed outcome is reached. The second score corresponds to a probability of the autonomous computerized agent ultimately achieving the successful outcome. The performances of the autonomous computerized agents are then evaluated based on the first score and the second score. The method of the present disclosure encapsulates not only the agent's ability to directly resolve requests but also their contribution to guiding requests through the routing process towards successful resolution. By incorporating the expected number of transitions, the agents are evaluated on their individual performance, as well as their respective role in facilitating the flow of requests through the system. This holistic approach provides a more nuanced understanding of each agent's effectiveness within the broader context of request resolution pathways, allowing for more informed decision-making in agent assignment and resource allocation.

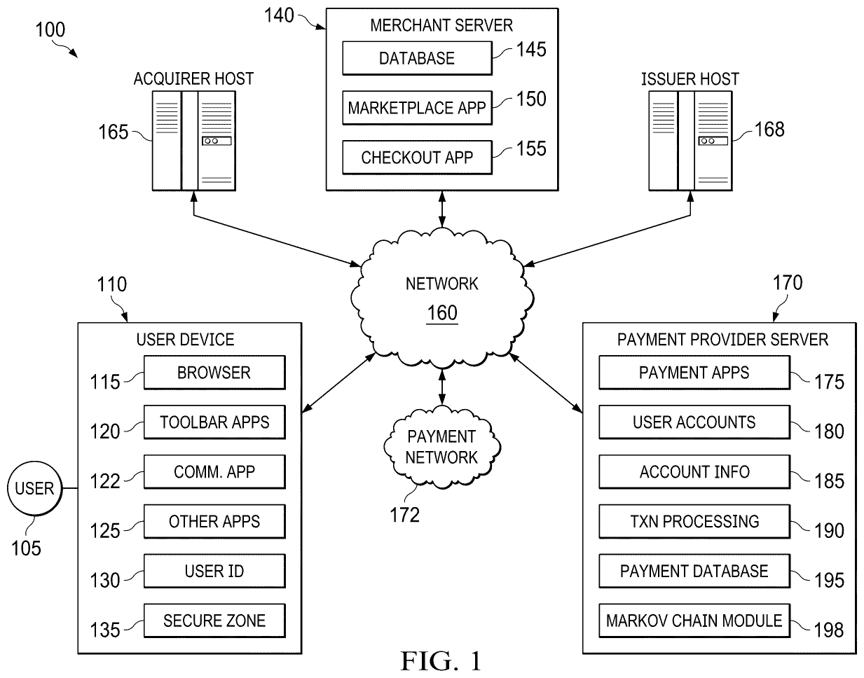

The various aspects of the present disclosure are discussed in more detail with reference to FIGS. 1-8. Referring to FIG. 1, a block diagram of a networked system 100 is illustrated. The networked system 100 provides an architecture suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a payment provider server 170, an acquirer host 165, an issuer host 168, and a payment network 172 that are in communication with one another over a network 160. Payment provider server 170 may be maintained by a payment service provider, such as PayPal™, Inc. of San Jose, CA. A user 105, such as a consumer or a customer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Before, during, or after the transaction, user 105 may engage, through user device 110, with a computerized agent to assist with the transaction. Although only one merchant server is shown, a plurality of merchant servers may be utilized if the user is purchasing products from multiple merchants.

User device 110, merchant server 140, payment provider server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the payment providers system/age/risk level and other similar parameters.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

According to various aspects of the present disclosure, the merchant server 140 may also host a website for an online marketplace, where sellers and buyers may engage in purchasing transactions with each other. The descriptions of the items or products offered for sale by the sellers may be stored in the database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a Markov Chain module 198 may also be implemented on the payment provider server 170. The Markov Chain module 198 may include one or more software applications or software programs that can be automatically executed (e.g., without needing explicit instructions from a human user) to perform certain tasks. For example, the Markov Chain module 198 may be used to construct one or more Markov chains that are used to provide explainability to a prediction generated by a machine learning model. For example, a machine learning model may be trained based on a plurality of data features, and an importance of each of the data features is estimated. The Markov Chain module 198 may then construct a Markov chain based on the estimated importance of the data features, such that the estimated importance of each data feature corresponds to a different state in the Markov chain. An explanation of the prediction (made by the machine learning model) may then be generated via a traversal of the Markov chain.

As another example, the Markov Chain module 198 may be used to construct one or more Markov chains that are used to evaluate an autonomous agent's performance in a multi-agent collaboration context. For example, historical performance information of a plurality autonomous agents that are configured to handle a plurality of tasks is obtained. The historical performance information indicates, for each autonomous agent of the plurality of autonomous agents, a successful outcome or a failed outcome for each task of the plurality of tasks handled by the autonomous agent. The Markov chain module 198 may then construct a Markov chain based on the autonomous agents, such that each autonomous agent corresponds to a different transient state of the Markov chain, which also include absorbing states that correspond to a successful outcome or a failed outcome of executing the task. For each autonomous agent, a first score and a second score are calculated based on the Markov chain. The first score corresponds to an expected number of transitions from the autonomous agent to other autonomous agents until the successful outcome or the failed outcome is reached. The second score corresponds to a probability of the autonomous agent ultimately achieving the successful outcome. The performance of the autonomous agents may then be evaluated based on the first score and the second score.

It is noted that although the Markov Chain module 198 is illustrated as being separate from the transaction processing application 190 in the embodiment shown in FIG. 1, the transaction processing application 190 may implement some, or all, of the functionalities of the Markov Chain module 198 in other embodiments. In other words, the Markov Chain module 198 may be integrated within the transaction processing application 190 in some embodiments. In addition, it is understood that the Markov Chain module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the Markov Chain module 198 may include one or more sub-modules that are configured to perform specific tasks. For example, the Markov Chain module 198 may include a sub-module configured to provide explainability to a machine learning-generated prediction and another sub-module configured to evaluate the performance of an autonomous computerized agent.

Still referring to FIG. 1, the payment network 172 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

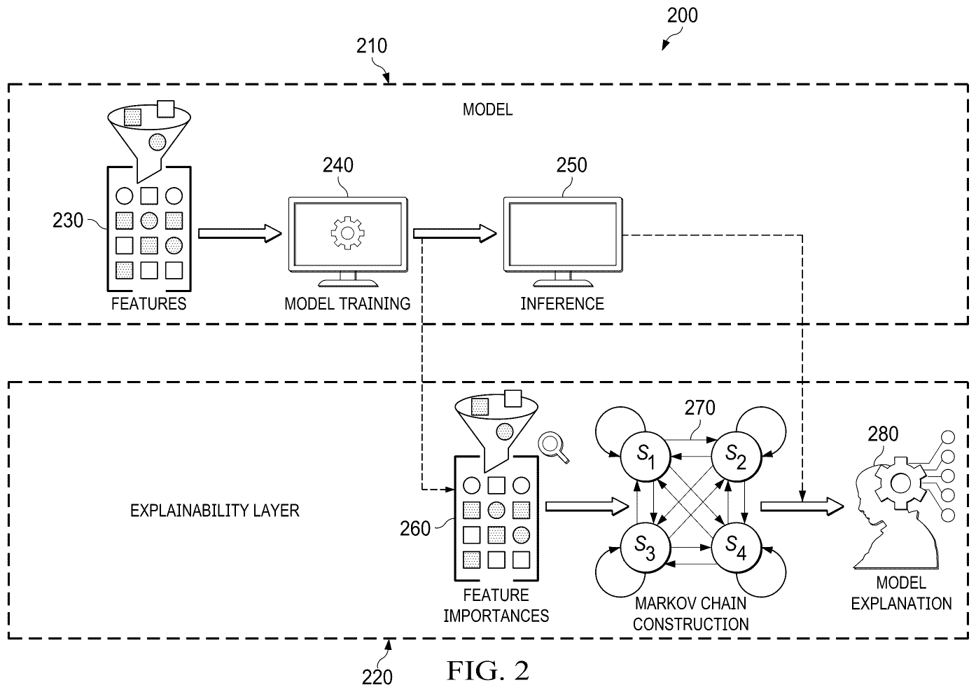

FIG. 2 illustrates a simplified block diagram corresponding to a process flow 200 for using a Markov chain to explain machine learning predictions. The process flow 200 is performed through two layers: a model layer 210 and an explainability layer 220. Beginning with the model layer 210, the process flow 200 begins with a step 230 in which a plurality of features are accessed. In the context of machine learning, a feature may refer to an individually measurable property within a recorded dataset. For example, a feature may correspond to a variable or an attribute of a dataset. In some embodiments, the plurality of features accessed in the step 230 may include, but are not limited to: a user login credential, a transaction amount, a transaction volume, a physical address associated with the transaction, a phone number associated with the transaction, an email address associated with the transaction, a domain name of an email address, a user name of the email address, an Internet Protocol (IP) address from which the transaction originated, a payment frequency, the type of goods purchased, a demographic of a seller or a buyer, a geographical location of the seller or the buyer, etc. The plurality of features may be collected from historical transactions involving a plurality of users over time, and the features may be saved in an electronic database. The plurality of features, or a subset thereof, may then be retrieved at a later time to perform machine learning model training.

The process flow 200 proceeds to a step 240 in the model layer 210, in which a machine learning model training is performed based on the features collected or otherwise accessed in step 230. In some embodiments, the machine learning model may include an ensemble model, such as a Random Forest model or an XGBoost model, where multiple models are combined to improve the overall performance and accuracy of predictions. Rather than relying on a single model, the ensemble model may use several models and merge their results to make a final decision. Among other things, the ensemble approach of machine learning helps to reduce errors, improve robustness, and increase the reliability of predictions by leveraging the strengths of different models. It is understood, however, that the concepts of the present disclosure are not limited to ensemble models unless otherwise claimed, and that other types of machine learning models may be trained in step 240 as well.

The process flow 200 proceeds to a step 250 in the model layer 210, in which an inference is made by the machine learning model trained in step 240. In more detail, the inference comprises one or more predictions or decisions made by the trained machine learning model on new, unseen data. In some cases, after a model has been trained on a dataset, it can be applied to new input data to infer or predict outcomes based on the patterns it learned during training. For example, if a model has been trained to recognize images of cats and dogs, the inference produced by that model is the classification of new images as either cats or dogs. In some embodiments, the inference generated in step 250 may identify data patterns that are associated with fraud (e.g., a transaction originating from a particular location, from a predefined IP address, or a particular pattern of sequence of events). In some other embodiments, the inference generated in step 250 may be an assessment of a credit risk of a transaction, such as providing a loan or a line of credit to a borrower. In yet embodiments, the inference generated in step 250 may be a medical diagnosis. For example, the inference may be used to assist clinicians in predicting diseases based on patient data. In some other embodiments, the inference generated in step 250 may be used for drug discovery in a pharmaceutical context. In other embodiments, the inference generated in step 250 may be used to provide personalized recommendations in the field of e-commerce and/or marketing, and/or to optimize a marketing campaign. In further embodiments, the inference generated in step 250 may be used to forecast demand and/or perform quality control in the field of supply chain management. In still other embodiments, the inference generated in step 250 may be used to detect anomalies in a cybersecurity context.

The process flow 200 also includes a step 260 in the explainability layer 220, in which feature importances are estimated. It is understood that the step 260 is performed independently of the step 250 (e.g., generating an inference), and it may be performed before, during, or after the step 250 is performed. In any case, as a part of the step 260, the importance of each of the features accessed in step 230 (or a subset thereof) may be calculated using a method such as Gini impurity, or a permutation importance. As a result of the calculation, the most important features among the features accessed in step 230 may be revealed. In some embodiments, the estimate generated by step 260 may include a ranked list of the importance of the features. The importance of the features may also vary depending on the particular type of inference the machine learning model is meant to generate, and that different rankings of important features may be generated for different types of inferences. For example, the step 250 may generate an estimate that an age of a user may be the most important feature, and that a country of origin of the user may be the second most important feature, when the inference is for an assessment of a creditworthiness of a borrower. On the other hand, the step 250 may generate an estimate that an IP address associated with the transaction may be the most important feature, and that a transaction amount may be the second most important feature, when the inference is to detect potential fraud in a transaction. In some embodiments, the feature importances estimated by step 260 are outputted as a set of scores, where each score represents an estimated importance of a particular feature.

The process flow 200 proceeds to a step 270 in the explainability layer 220, in which a Markov chain is constructed. In that regard, a Markov chain is a stochastic (e.g., involving randomness) model describing a set of states that can undergo transitions from one state to another, where a probability of transitioning to any particular state depends on the current state, but not the states (or sequences of state transitions) that precede the current state. A typical Markov chain may be described based on its total number states, an initiate state, a transition probability, and a transition probability matrix. The total number of states may correspond to the total number of potential conditions or configurations associated with the Markov chain. In some embodiments, each state may represent a particular event. The initial state may correspond to the state from which a Markov process begins. The transition probability refers to a probability of transitioning from one state to another state of the Markov chain. The transition probability matrix is a matrix that describes the probabilities of transitioning from one state to another state of the Markov chain.

According to the various aspects of the present disclosure, the Markov chain constructed in step 270 is constructed based on the results of the step 260. For example, the Markov chain of step 270 may be constructed using the feature importance scores obtained in step 260. In some embodiments, each feature may be considered a state in the Markov chain, and transition probabilities between the features are computed based on their importance scores. This step 270 captures the relationships between the features in the context of model decisions. The construction of the transition probability matrix is described in detail below:
Normalization of the Feature Importance Scores: Before constructing the transition probability matrix, the feature importance scores (e.g., obtained as a result of step 260) are normalized to ensure that they add up to 1. This normalization step ensures that the transition probabilities accurately reflect the relative importance of each of the features in the context of the entire feature set.
Pairwise Comparison of Feature Importance: For each pair of features (e.g., a hypothetical Feature A and a hypothetical Feature B), the normalized importance scores are compared. For case of reference, the normalized importance score of Feature A is denoted as I_{A}, and the normalized importance score of Feature B is denoted as I_{B}.
Relative Importance Comparison: The transition probability from Feature A to Feature B (P_{AB}) is determined based on the relative importance of Feature A compared to Feature B. An example approach is to calculate the transition probability as the ratio of the importance score of Feature A to the sum of the importance scores of Feature A and Feature B:

$${P}_{AB} = \frac{{I}_{A}}{{I}_{A} + {I}_{B}}$$

Similarly, the transition probability from Feature B to Feature A (P_{BA}) can be calculated as:

$${P}_{BA} = \frac{{I}_{B}}{{I}_{A} + {I}_{B}}$$

The transition probabilities represent the likelihood of transitioning from one feature to another in the Markov chain, given the importance of the features in the context of the machine learning model. Higher transition probabilities indicate stronger connections between features, suggesting a higher likelihood of one feature influencing the other in the decision-making process of the model.
Incorporating Feature Correlation: Additionally, each transition probability is multiplied by a value derived from the correlation between the two features. The correlation coefficient between Feature A and Feature B may be denoted as ρ_{AB}. The adjusted transition probabilities are calculated as follows:

$${P}_{AB} = {P}_{AB} \cdot ( 1 - \vert {ρ}_{AB} \vert ) \\ {P}_{BA} = {P}_{BA} \cdot ( 1 - \vert {ρ}_{AB} \vert )$$

By incorporating the absolute value of correlation between features into the calculation of transition probabilities, the probabilities are adjusted to reflect the degree of redundancy or similarity between the features. When two features are highly correlated (positively or negatively), their transition probabilities are reduced, indicating that the model may rely less on both features for decision-making. In addition to utilizing feature correlation coefficients derived from data analysis, the method of the present disclosure allows for the incorporation of correlation values provided by domain experts, enabling the integration of expert knowledge about the relationships between features into the calculation of transition probabilities. Moreover, alternative inputs, such as domain-specific rules or domain-specific weights assigned to feature pairs, could also be explored to tailor the explainability framework according to specific business requirements and expert insights, further enhancing the accuracy and relevance of model explanations.
Normalization of Probabilities: After calculating the transition probabilities for each pair of features, a check is made to ensure that they add up to 1 along each row of the transition probability matrix, an example of which will be provided below for purposes of illustration. This normalization step allows the probabilities to accurately represent valid transitions between the states in the Markov chain.

The process flow 200 proceeds to a step 280 in the explainability layer 220, in which a model explanation is generated. For example, the inference produced in step 250 may be explained based on the Markov chain constructed in step 270. In more detail, once the transition probability matrix in the Markov chain is constructed in step 270, explanations for individual machine learning model predictions (e.g., the inference made by step 250) can be generated using the Markov chain. Given a specific prediction made by the machine learning model, the Markov chain is traversed to identify the sequence of features that contributed most significantly to the prediction. This sequence serves as an explanation for the model's decision, offering insights into the underlying logic. The explanations derived from the Markov chain traversal can be visualized in various forms, such as feature importance plots, decision trees, or interactive dashboards. Users can interactively explore the contributions of different features to model predictions, thereby gaining a deeper understanding of the machine learning model behavior.

To facilitate the understanding of the steps 230-280 of the process flow 200, a simplified example is provided below. In this simplified example, a Random Forest machine learning model is used to predict the risk for a seller on an e-commerce platform based on five features obtained from step 230: 1) credit score; 2) transaction volume; 3) product category; 4) customer reviews; and 5) behavioral consistency. The calculations will now be explained step-by-step to demonstrate the explainability of the model using Markov chains.

Suppose the following feature importance scores obtained from the machine learning model (e.g., from step 260):
Credit Score: 0.42
Transaction Volume: 0.35
Product Category: 0.28
Customer Reviews: 0.49
Behavioral consistency: 0.14

As discussed above in step 270, one aspect of the Markov chain construction involves the normalization of feature importance scores. In some embodiments, the feature importance scores are normalized so that they add up to 1. For example, since the sum of the feature scores of the five features above is 1.68 (0.42+0.35+0.28+0.49+0.14=1.68), each feature score can be normalized by dividing the feature score by 1.68. To illustrate, the importance of Credit Score is normalized by

$$\frac{0.42}{{\sum }_{i = 1}^{5} {I}_{i}} = \frac{0.42}{1.68} = 0.3 .$$

Expressed as a vector, the normalized importance scores of the five features above would be:
[0.3,0.25,0.2,0.35,0.1]

Next, a transition probability matrix is constructed. According to the various aspects of the present disclosure, the transition probabilities between pairs of features are calculated based on their normalized importance scores. The transition probability matrix, prior to normalization, may be denoted as P:

$$P = ( \begin{matrix}0 & 0.4545 & 0.4 & 0.5385 & 0.25 \\ 0.5455 & 0 & 0.444 & 0.5833 & 0.2857 \\ 0.6 & 0.5556 & 0 & 0.6363 & 0.3333 \\ 0.4615 & 0.4167 & 0.3636 & 0 & 0.2222 \\ 0.75 & 0.7142 & 0.6667 & 0.7778 & 0\end{matrix} )$$

In the above transition probability matrix, there are five rows and five columns. Each row and each column represents a feature, and the values in the matrix denote the transition probabilities, prior to normalization, from one feature to another. For example, P₂₃ (e.g., column 2 row 3) shows the transition probability from the second feature (Transaction Volume) to the third feature (Product Category), and it is calculated as

$$\frac{0.25}{0.25 + 0.2} = \frac{0.25}{0.45} = 0.5 56.$$

As another example, P₄₅ (e.g., column 4 row 5) shows the transition probability from the fourth feature (Customer Reviews) to the fifth feature (Behavioral consistency), and it is calculated

$$as \frac{0.49}{0.49 + 0.14} = \frac{0.49}{0.63} = 0.7778 .$$

Next, each value in the matrix is multiplied by the value of a correlation factor. For example, the following Table 1 corresponds to the matrix of correlation factor.

TABLE 1

| | Credit | Transaction | Product | Customer | Behavioral |
|---|---|---|---|---|---|
| Feature | Score | Volume | Category | Reviews | Consistency |
| Credit | 1 | 0.003 | −0.009 | 0.332 | −0.007 |
| Score | | | | | |
| Trans- | 0.003 | 1 | −0.192 | −0.112 | 0.495 |
| action | | | | | |
| Volume | | | | | |
| Product | −0.009 | −0.192 | 1 | −0.008 | −0.166 |
| Category | | | | | |
| Customer | 0.332 | −0.012 | −0.008 | 1 | 0.003 |
| Reviews | | | | | |
| Behavioral | −0.007 | 0.495 | −0.166 | 0.003 | 1 |
| Consis- | | | | | |
| tency | | | | | |

The updated transition probability matrix (after normalization) is:

$$P = ( \begin{matrix}0 & 0.311 & 0.272 & 0.247 & 0.17 \\ 0.335 & 0 & 0.221 & 0.355 & 0.089 \\ 0.304 & 0.23 & 0 & 0.323 & 0.142 \\ 0.237 & 0.316 & 0.277 & 0 & 0.17 \\ 0.306 & 0.148 & 0.228 & 0.318 & 0\end{matrix} )$$

Next, an explanation is generated based on the above transition probability matrix after normalization. For example, suppose that the inference from the step 250 is that the machine learning model predicts a high risk (e.g., a risk score above a specified threshold) for a seller. Such an inference can be explained by traversing the Markov chain to identify the sequence of features contributing to this inference. For example, starting from the feature with the highest feature importance score (Customer Reviews, which had a feature importance score of 0.49 before normalization or 0.35 after normalization), the Markov chain is traversed by selecting the feature with the highest transition probability at each step until the predicted outcome (high risk) is reached. For example, the traversal may start at Customer Reviews (since this feature has the highest feature importance score), which corresponds to row 4 of the transition probability matrix. Next, the maximum value in row 4 is identified, which is 0.316. The value 0.316 in row 4 is in column 2, which corresponds to the feature of Transaction Volume. The feature Transaction Volume corresponds to row 2, and the highest value in row 2 of the transition probability matrix is 0.355. However, that value is in column 4, which corresponds to Customer Reviews, and that is a feature that has already been traversed. Therefore, the next highest value in row 2 is identified, which is 0.335. This value is in column 1 and corresponds to Credit Score, which corresponds to row 1.

The above process may repeat until entire probability matrix is traversed (e.g., no more new features), or after a satisfactory number of features have been identified after several traversal iterations. Based on the example traversal of the Markov chain discussed above (e.g., starting at Customer Reviews and Ending at Credit Score), the inference of high risk for the seller can be interpreted as primarily driven by customer reviews, followed by transaction volume, and then by credit score. It is noted that although Credit Score was ranked #2 in the original feature importance, its importance in the example traversal of the transition probability matrix is decreased, as it is correlated with the Customer Reviews feature. This sequential explanation provides valuable insights into the decision-making process of the machine learning model, which enhances its interpretability, transparency, and trustworthiness.

The concepts of the present disclosure discussed above may have applications across various domains, including healthcare, finance, and cybersecurity, where interpretability of machine learning models is paramount. Several non-limiting examples of the applications are briefly explained below:

### 1. Finance and Banking:

Credit Risk Assessment: Banks and financial institutions can use machine learning models enhanced with Markov chains for credit risk assessment. By understanding the sequence of influential features in the decision-making process, banks can provide more transparent explanations for credit decisions, improving customer trust and regulatory compliance.
Fraud Detection: Enhanced explainability can aid in fraud detection by providing insights into the features driving fraudulent behavior. Markov chain-based explanations can help investigators understand the sequential patterns of fraudulent activities, leading to more effective fraud prevention strategies.

### 2. Healthcare:

Diagnostic Support: In medical diagnosis, machine learning models can assist clinicians in predicting diseases based on patient data. By incorporating Markov chains, clinicians can gain insights into the sequence of symptoms or biomarkers contributing to a diagnosis. This can help in refining treatment plans and explaining diagnostic decisions to patients.
Drug Discovery: Pharmaceutical companies can utilize enhanced explainability to interpret machine learning models used in drug discovery. Understanding the sequence of specific features important for drug efficacy or toxicity can guide researchers in designing more effective and safer drugs.

### 3. E-Commerce and Marketing:

Personalized Recommendations: Online retailers can leverage enhanced explainability to provide more transparent product recommendations to customers. By revealing the sequence of user behaviors and product features influencing recommendations, retailers can improve customer satisfaction and increase sales.
Marketing Campaign Optimization: Marketers can use machine learning models with integrated Markov chains to analyze customer behavior and optimize marketing campaigns. Understanding the sequential patterns of customer interactions with advertisements or promotions can lead to more targeted and effective marketing strategies.

### 4. Supply Chain Management:

Demand Forecasting: Enhanced explainability can improve the accuracy of demand forecasting models used in supply chain management. By uncovering the sequence of factors driving demand fluctuations, businesses can better anticipate inventory needs and optimize supply chain operations.
Quality Control: Manufacturers can employ Markov chain-enhanced machine learning models for quality control purposes. By identifying the sequential patterns of manufacturing defects or process variables leading to product defects, manufacturers can implement corrective actions and improve product quality.

### 5. Cybersecurity:

Anomaly Detection: Security analysts can utilize Random Forest models with integrated Markov chains for anomaly detection in network traffic or system logs. By understanding the sequential patterns of suspicious activities or system events, analysts can detect and respond to cybersecurity threats more effectively.

In addition to using Markov chains to provide explainability of machine learning predictions, another aspect of the present disclosure pertains to using Markov chains to evaluate the performance of autonomous computerized agents. In more detail, autonomous computerized agents, such as the electronic chatbots developed based on Large Language Models (LLMs), have been deployed in various domains, including but not limited to customer support, data query, or technical assistance. However, existing methods and systems for evaluating the performance of these autonomous computerized agents often lack the sophistication needed to capture the complexities of multi-agent interactions. Current methods typically rely on simplistic metrics like success rates or failure counts for individual autonomous computerized agents, without considering the intricacies of collaborative request resolution involving multiple computerized agents.

For example, in dynamic environments where requests may traverse through several autonomous computerized agents before reaching a successful resolution, traditional scoring mechanisms typically fail to provide a comprehensive assessment of agent effectiveness and/or does not sufficiently distinguish between effective routing strategies and suboptimal practices. For example, in a simplified scenario where two autonomous computerized agents are collaborating with many other autonomous computerized agents to handle a request from a user, one agent consistently forwards requests to the most suitable agent, leading to successful resolutions, while the other agent indiscriminately routes requests to irrelevant agents, resulting in failures or unnecessary delays. Traditional evaluation methods might inaccurately label both agents as equally successful or unsuccessful based solely on individual outcomes. For example, traditional evaluation methods may predominantly focus on individual agent performance metrics, such as accuracy or response time, in isolation, but they often overlook the collaborative aspect of request resolution and may not accurately reflect the collective impact of multiple agents working together. Furthermore, traditional evaluation methods may lack the ability to quantify the effectiveness of multi-agent routing strategies and identify opportunities for optimization in the overall routing process. Without a comprehensive evaluation framework that considers the interactions between individual autonomous computerized agents, entities that deploy these agents may struggle to leverage the full potential of their AI-powered support systems. Consequently, there is a pressing need for an evaluation system that can accurately measure the contribution of each autonomous computerized agent to the overall success of request resolution by taking into account the collaborative nature of the routing process.

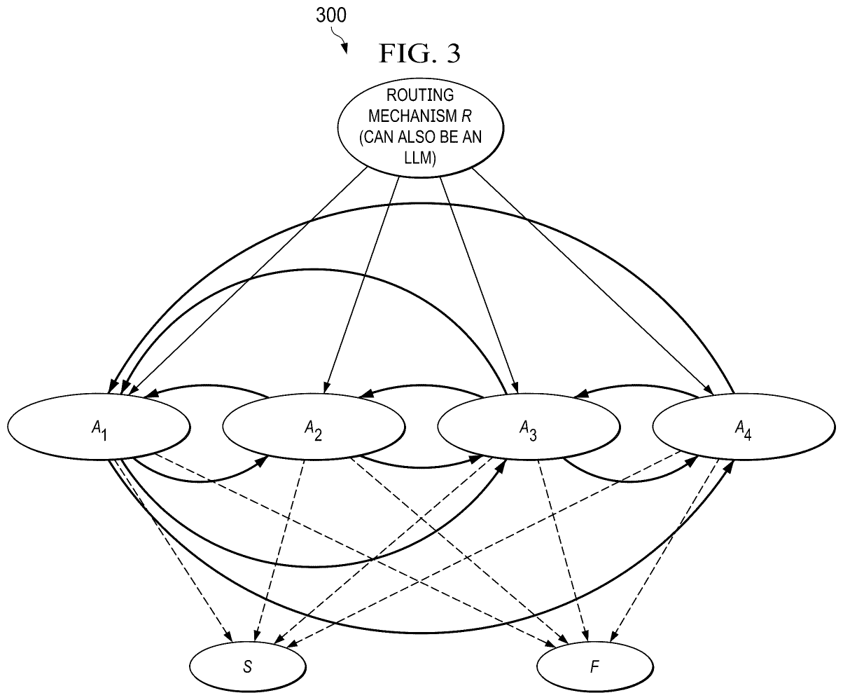

The present disclosure provides a sophisticated evaluation system that evaluates the overall effectiveness of request routing by quantifying the contributions of each agent to successful resolution pathways over time, which provides valuable insights for optimizing routing strategies, enhancing agent performance, and ultimately improving customer satisfaction. In more detail, the present disclosure involves a Markov-Chain-based scoring system, where each autonomous computerized agent is defined as a state of the Markov chain. Additionally, two additional states are included in the Markov chain to signify the resolution outcomes of any query-success or failure. The transition probabilities between each state are initially calculated after a predefined number of queries in the system, and they reflect the frequency with which an autonomous computerized agent i forwards the request to another autonomous computerized agent j or if the request reaches a resolution state. The transition probabilities are updated dynamically as more requests flow through the system, as discussed below in more detail with reference to FIG. 3.

Referring now to FIG. 3, a diagram of a Markov chain 300 is illustrated. The Markov chain 300 may be constructed based on historical performance information of a plurality of autonomous computerized agents that are configured to execute a plurality of tasks (e.g., a query or a request from a user). For example, the historical performance information may indicate, for each autonomous computerized agent, a successful outcome or a failed outcome for each task handled by the autonomous computerized agent. In some embodiments, at least a subset of the autonomous computerized agents comprise computer chatbots configured for customer support or for diagnostics. In some embodiments, at least a subset of the autonomous computerized agents comprise one or more Large Language Models (LLMs). In some embodiments, a first one of the autonomous computerized agents comprises a first type of LLM, and a second one of the autonomous computerized agents comprises a second type of LLM different from the first type. In some embodiments, a first one of the autonomous computerized agents comprises an LLM agent trained in a first field, and a second one of the autonomous computerized agents comprises a second LLM agent trained in a second field different from the first field.

The Markov chain 300 includes a plurality of states, such as A1, A2, A3, A4, S, and F. The states A1-A4 each represent a different autonomous computerized agent, the state S represents a successful outcome (e.g., a successful resolution of a request or a query sent handled by the autonomous computerized agents), and the state F represents an unsuccessful outcome (e.g., a failed resolution of a request or a query handled by the autonomous computerized agents). For example, a successful outcome may include an outcome where a request from a user is approved, or when a query from a user is given an answer. Meanwhile, an unsuccessful outcome may include an outcome where the request from the user is denied or when none of the agents is able to execute a task associated with the request, or when none of the agents is able to find an answer for the query from the user. The states A1, A2, A3, and A4 are interconnected with one another, which represents the fact that a quest or a query sent for execution by any one of the autonomous computerized agents corresponding to the states A1-A4 can be forwarded to any other one of the autonomous computerized agents corresponding to the states A1-A4. The states A1-A4 are also each connected to the states S and F, which reflects the fact that any one of the autonomous computerized agents corresponding to the states A1-A4 can reach a successful outcome represented by the state S or an unsuccessful outcome represented by the state F. The Markov chain 300 further includes a routing mechanism R that is connected to all the states A1-A4. The routing mechanism R may be configured to facilitate the routing of the query or request within the system represented by the Markov chain 300. In various embodiments, the routing mechanism R may be in the form of a classifier, an LLM agent, or it may operate randomly.

In the Markov chain 300, the states A1-A4 may be referred to as transient states. That is, a query or request may transition from one of the states A1-A4 to another other one of the states A1-A4 as a part of the handling of the query or request. Meanwhile, the states S and F may be referred to as absorbing states. That is, once they are entered, the query or request is considered to have achieved resolution and therefore cannot transition into any one of the other states. According to various aspects of the present disclosure, each autonomous computerized agent associated with the Markov chain 300 may be evaluated (e.g., having a numeric score generated for it) by using:
1) the expected number of steps before reaching resolution; and
2) the probability this agent ultimately achieves the Successful resolution (e.g., reaching the state S).

In general, if the Markov chain 300 has r absorbing states and t transient states (the states describing the agents), a transition matrix may be generated for the Markov chain 300 to have the following canonical form:

$$P = \begin{matrix}TR . \\ ABS .\end{matrix} {( \begin{matrix}Q & R \\ 0 & I\end{matrix} )}^{\begin{matrix}TR . & ABS .\end{matrix}}$$

The first t states are transient, and the last two states are absorbing. I is a 2-by-2 identity matrix, 0 is a 2-by-t zero matrix, TR represents the transient states, R is a nonzero t-by-2 matrix, and Q is a t-by-t matrix. The entry

$${p}_{ij}^{( n )}$$

of the matrix P n is the probability of being in the state sⱼ after n steps, when the Markov chain is started in the state sᵢ.

For an absorbing Markov chain P, the matrix N=(I−Q)⁻¹ is called the fundamental matrix for P. The entry nᵢⱼ of N gives the expected number of times that the process is in the transient state sⱼ if it is started in the transient state sᵢ. Bᵢⱼ is the probability that an absorbing chain will be absorbed in the absorbing state sⱼ if it starts in the transient state sᵢ. B is the matrix with entries bᵢⱼ. For example, B may be an t-by-2 matrix, and B=NR, where N is the fundamental matrix, and R is as in the canonical form. In other words, the number of rows of matrix B is the number of autonomous computerized agents, and it has two columns-one for the successful resolution and the other is for a failed resolution.

In this manner, rank each agent i can be ranked by:
1) the expected number of transitions until resolution is reached (e.g., the sum of values in the iₜₕ column in the fundamental matrix); and
2) the probability of achieving the successful resolution. (e.g., the value each one in the success column)

Expanding upon this concept, individual agent metrics can be extended to include the expected number of steps before resolution. This new metric encapsulates not only the agent's ability to directly resolve requests, but also their contribution to guiding requests through the routing process towards a successful resolution. By incorporating the expected number of steps, the agents are evaluated not solely on their individual performance, but also on their role in facilitating the flow of requests through the system. This holistic approach provides a more nuanced understanding of each agent's effectiveness within the broader context of request resolution pathways, allowing for more informed decision-making in agent assignment and resource allocation.

The table 2 below illustrates the above concepts with a Markov chain corresponding to a system with three agents (e.g., corresponding to states A1, A2, and A3 of the Markov chain 300, where the state A4 is inactive or otherwise deactivated) and two absorbing states (Success and Fail, which is represented by the states S and F in FIG. 3):

TABLE 2

| state | 1 | 2 | 3 | Success | Fail |
|---|---|---|---|---|---|
| 1 | 0 | 0.1 | 0.2 | 0.6 | 0.1 |
| 2 | 0.4 | 0 | 0.2 | 0.15 | 0.25 |
| 3 | 0.25 | 0.25 | 0 | 0.3 | 0.2 |
| Success | 0 | 0 | 0 | 1 | 0 |
| Fail | 0 | 0 | 0 | 0 | 1 |

From the canonical form of Q and R below:

$$Q = ( \begin{matrix}0 & 0.1 & 0.2 \\ 0.4 & 0 & 0.2 \\ 0.25 & 0.25 & 0\end{matrix} ) \\ R = ( \begin{matrix}0.6 & 0.1 \\ 0.15 & 0.25 \\ 0.3 & 0.2\end{matrix} )$$

The following calculations are made:

$$I - Q = ( \begin{matrix}1 & 0 & 0 \\ 0 & 1 & 0 \\ 0 & 0 & 1\end{matrix} ) - ( \begin{matrix}0 & 0.1 & 0.2 \\ 0.4 & 0 & 0.2 \\ 0.25 & 0.25 & 0\end{matrix} ) = ( \begin{matrix}1 & - 0.1 & - 0.2 \\ - 0.4 & 1 & - 0.2 \\ - 0.25 & - 0.25 & 1\end{matrix} ) \\ N = {( \begin{matrix}1 & - 0.1 & - 0.2 \\ - 0.4 & 1 & - 0.2 \\ - 0.25 & - 0.25 & 1\end{matrix} )}^{- 1} = ( \begin{matrix}1.13 & 0.18 & 0.26 \\ 0.54 & 1.13 & 0.34 \\ 0.42 & 0.33 & 1.15\end{matrix} ) \\ B = NR = ( \begin{matrix}1.13 & 0.18 & 0.26 \\ 0.54 & 1.13 & 0.34 \\ 0.42 & 0.33 & 1.15\end{matrix} ) \cdot ( \begin{matrix}0.6 & 0.1 \\ 0.15 & 0.25 \\ 0.3 & 0.2\end{matrix} ) = ( \begin{matrix}0.79 & 0.21 \\ 0.6 & 0.4 \\ 0.65 & 0.35\end{matrix} )$$

Based on the above calculations, the performance of each agent can be evaluated. In more detail, for any given agent, the expected number of steps (e.g., transitions among the states of the Markov chain) before reaching a resolution (e.g., before reaching the states S or F) can be determined by summing the values in the corresponding column of the matrix N. For example, for agent 1, its corresponding column in the matrix N is the first column, which has the values 1.13, 0.54, and 0.42. By summing these values, a score of 2.09 is obtained, which represents the expected number of steps before reaching either a successful outcome(S) or an unsuccessful outcome (F). Similarly, for agent 2 and agent 3, their corresponding expected number of steps before reaching either the successful outcome or unsuccessful outcome are calculated as scores of 1.64 and 1.75, respectively. Meanwhile, the probability of a successful resolution for agents 1, 2, and 3 are represented by the scores in the first column of the matrix B, which are 0.79, 0.6, and 0.65, respectively. The table 3 below illustrates the two types of scores:

TABLE 3

| | Expected number of steps | Probability of |
|---|---|---|
| | before resolution (The sum | successful |
| Agent | of column i in matrix N) | resolution |
| 1 | 2.09 | 0.79 |
| 2 | 1.64 | 0.6 |
| 3 | 1.75 | 0.65 |

In some embodiments, the agent's performance is deemed better with a smaller score for the expected number of steps before resolution (e.g., smaller score in column 2 of Table 3 above), but a greater score for the probability of successful resolution (e.g., greater score in column 3 of Table 3 above). In other words, a well-performing agent should not need an excessive number of steps before reaching a resolution, and it should also have a high probability of achieving a successful resolution. In any case, the performance of any given agent can be quickly and objectively evaluated by looking up its corresponding scores in these two metrics.

The Markov-chain-based system and method for scoring autonomous computerized agents may have applications in a variety of business domains, where an accurate evaluation of multiple LLM agents' performance in a collaborative context is desirable in order to improve operational efficiency and customer satisfaction. Some potential use cases may include, but are not limited to:
1. Virtual Assistants: Assessing the performance of AI-powered virtual assistants composed of multiple specialized LLM agents in handling complex user inquiries across different domains.
2. Technical Support: Routing customer inquiries to LLM agents that are each trained with expertise in a specific technical domain or in multilingual customer support inquiries.
3. Healthcare: Directing patient queries to LLM agents specializing in different medical specialties or healthcare services.
4. Knowledge Management Systems: Evaluating the effectiveness of collaborative LLM agents in providing comprehensive and accurate responses to user queries by leveraging diverse expertise.
5. Content Generation Platforms: Analyzing the performance of collaborative LLM agents in generating high-quality and coherent content across various topics and languages.

In each of these scenarios, the Markov-chain-based scoring system offers a robust framework for quantifying the collective performance of multiple LLM agents in collaborative request resolution, which enables organizations to optimize resource allocation, enhance service quality, and improve overall user experience.

As discussed above with reference to FIG. 1, the Markov Chain module 198 is able to construct the Markov chain models that are then used to provide explanations for machine learning-generated predictions, or to provide the scoring mechanism for evaluating the performance of autonomous computerized agents in a multi-agent collaboration context. In this manner, the present application is a practical application of the ideas of providing explanations and/or evaluating performances. In such a practical application, the Markov Chain module 198 constructs various Markov chains, from which tangible results are obtained. For example, a traversal of one Markov chain model constructed by the Markov chain module 198 can reveal how and why a machine learning model generated a particular prediction, and the ranking of the various factors that are used to make such a prediction. As another example, scores generated by another Markov chain model constructed by the Markov chain module 198 can be used to accurately and objectively evaluate the performance of each autonomous computerized agent in the multi-agent collaboration context. In both of these real-world use scenarios, valuable insight that is otherwise hidden can be extracted by the output of the Markov Chain module 198, which then allows responsible entities to make more informed decisions.

Furthermore, the present disclosure is an improvement of computer technology. For example, in a fraud detection or a cybersecurity context, the Markov chain-based explanations can help investigators to better understand the sequential patterns of fraudulent activities and/or cybersecurity threats. Consequently, the deployment of computing systems in these fields can be optimized to reduce the waste of electronic resources (e.g., network traffic, computer processing power, electronic memory usage, electronic communication bandwidth, etc.). As another example, the Markov-Chain-based scoring system of the present disclosure can more accurately evaluate the performance of each autonomous computerized agent in a multi-agent collaboration context. As a result, poor performing autonomous computerized agents may be removed or replaced with better performing agents, which not only improves the overall performance of a multi-agent computer system (as the system can handle/execute the tasks faster and with more precision), but also frees up electronic resources that would have been wasted by the poor performing agents, as a part of the overall improvement in computer technology.

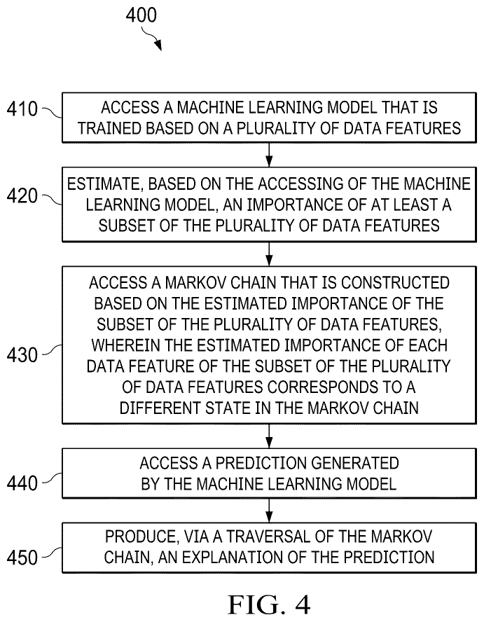

FIG. 4 is a flowchart illustrating a method 400 for generating explanations for machine learning predictions according to various aspects of the present disclosure. The various steps of the method 400, which have been described in greater detail above with reference to FIG. 2, may be performed by one or more electronic processors, for example by the processors of a computer of an entity that may include: a payment provider, a business analyst, or a merchant. The networked system described with respect to FIG. 1 is an example of a system that can perform the method 400. In some embodiments, at least some of the steps of the method 400 may be performed by the Markov Chain module 198 discussed above.

The method 400 includes a step 410 to access a machine learning model that is trained based on a plurality of data features. For example, the machine learning model may be the model trained in step 240 of FIG. 2 based on the features gathered in step 230 of FIG. 2. In some embodiments, the machine learning model comprises an ensemble model that is trained to perform one or more classification or regression tasks.

The method 400 includes a step 420 to estimate, based on the accessing of the machine learning model, an importance of at least a subset of the plurality of data features. For example, the importance of the features may be estimated by executing step 260 of FIG. 2. In some embodiments, step 420 is performed by assigning a numeric score to each estimated importance of the subset of the plurality of data features, and ranking the importance of the subset of the plurality of data features based on their respective assigned numeric scores.

The method 400 includes a step 430 to access a Markov chain that is constructed based on the estimated importance of the subset of the plurality of data features. For example, the Markov chain may be constructed at least in part by executing step 270 of FIG. 2. The estimated importance of each data feature of the subset of the plurality of data features corresponds to a different state in the Markov chain. In some embodiments, the Markov chain is constructed at least in part by generating, based on the estimated importance of the subset of the plurality of data features, a transition probability matrix. The transition probability matrix indicates a probability of transitioning between different pairs of the data features in the Markov chain. The probability of transitioning is correlated with a likelihood of an influence exerted by one data feature to another data feature in the pair of data features. In some embodiments, the Markov chain is further constructed by normalizing the estimated importance of the subset of the plurality of data features before the generating the transition probability matrix.

The method 400 includes a step 440 to access a prediction generated by the machine learning model. For example, the prediction may be the inference generated by step 250 of FIG. 2.

The method 400 includes a step 450 to produce, via a traversal of the Markov chain, an explanation of the prediction. For example, the explanation may be the model explanation produced by step 280 of FIG. 2. In some embodiments, the traversal of the Markov chain identifies a sequence of data features that contributed most significantly to the prediction. In some embodiments, the explanation comprises a feature importance plot, a decision tree, or an interactive dashboard.

It is understood that additional method steps may be performed before, during, or after the steps 410-450 discussed above. For example, the method 400 may include a step of gathering the features and/or training the machine learning model based on the features. As another example, the method 400 may include a step of providing the explanation of the prediction to a specified entity. For reasons of simplicity, these additional steps are not discussed in detailed herein.

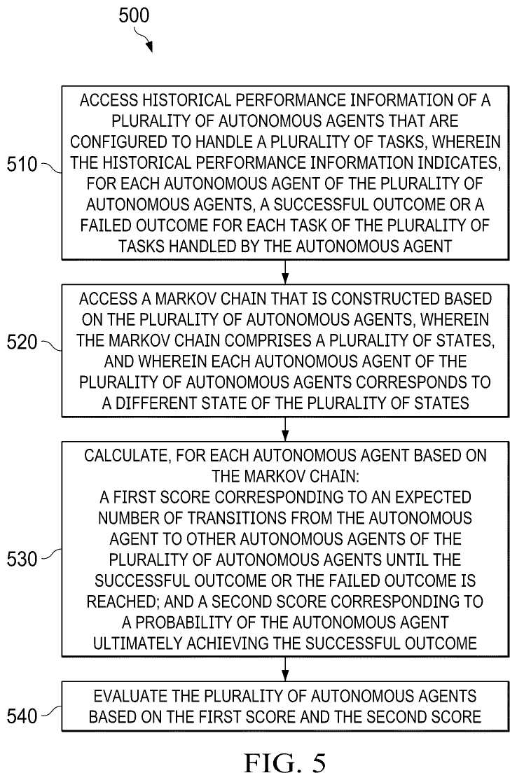

FIG. 5 is a flowchart illustrating a method 500 for evaluating the performance of an autonomous computerized agent in a multi-agent collaboration context according to various aspects of the present disclosure. The various steps of the method 500, which have been described in greater detail above with reference to FIG. 3, may be performed by one or more electronic processors, for example by the processors of a computer of an entity that may include: a payment provider, a business analyst, or a merchant. The networked system described with respect to FIG. 1 is an example of a system that can perform the method 500. In some embodiments, at least some of the steps of the method 500 may be performed by the Markov Chain module 198 discussed above.

The method 500 includes a step 510 to access historical performance information of a plurality of autonomous agents that are configured to handle a plurality of tasks. In some embodiments, at least a subset of the plurality of autonomous agents comprise computer chatbots configured for customer support or for diagnostics. In some embodiments, at least a subset of the plurality of autonomous agents comprise one or more Large Language Models (LLMs). In some embodiments, the autonomous agents comprise agents trained with different types of LLMs, and/or LLM agents trained in different fields. The historical performance information indicates, for each autonomous agent of the plurality of autonomous agents, a successful outcome or a failed outcome for each task of the plurality of tasks handled by the autonomous agent.

The method 500 includes a step 520 to access a Markov chain that is constructed based on the plurality of autonomous agents. The Markov chain comprises a plurality of states, and wherein each autonomous agent of the plurality of autonomous agents corresponds to a different state of the plurality of states. For example, the Markov chain may correspond to the Markov chain 300 of FIG. 3. In some embodiments, the Markov chain comprises a plurality of transient states and a plurality of absorbing states. For example, the transient states may correspond to the states A1-A4 of FIG. 3, and the absorbing states may correspond to the state S (representing a successful resolution) and the state F (representing a failed resolution). The plurality of autonomous agents represent the plurality of transient states, and the successful outcome and the failed outcome correspond to the plurality of absorbing states. In some embodiments, the Markov chain further comprises a routing mechanism, which may comprise a classifier or a Large Language Model (LLM). For example, the routing mechanism may be the routing mechanism R of FIG. 3.

The method 500 includes a step 530 to calculate, for each autonomous agent based on the Markov chain: a first score corresponding to an expected number of transitions from the autonomous agent to other autonomous agents of the plurality of autonomous agents until the successful outcome or the failed outcome is reached; and a second score corresponding to a probability of the autonomous agent ultimately achieving the successful outcome. For example, the first score may be the scores in column 2 of the Table 3 above, and the second score may be the scores in column 3 of the Table 3 above.

The method 500 includes a step 540 to evaluate the plurality of autonomous agents based on the first score and the second score. In some embodiments, the performance of the autonomous agents may be ranked based on the first score and/or the second score.

It is understood that additional method steps may be performed before, during, or after the steps 510-540 discussed above. For example, the method 500 may include a step of constructing the system that comprises the plurality of autonomous agents. As another example, the method 500 may include a step of providing the evaluation of the autonomous agents to a specified entity. For reasons of simplicity, these additional steps are not discussed in detailed herein.

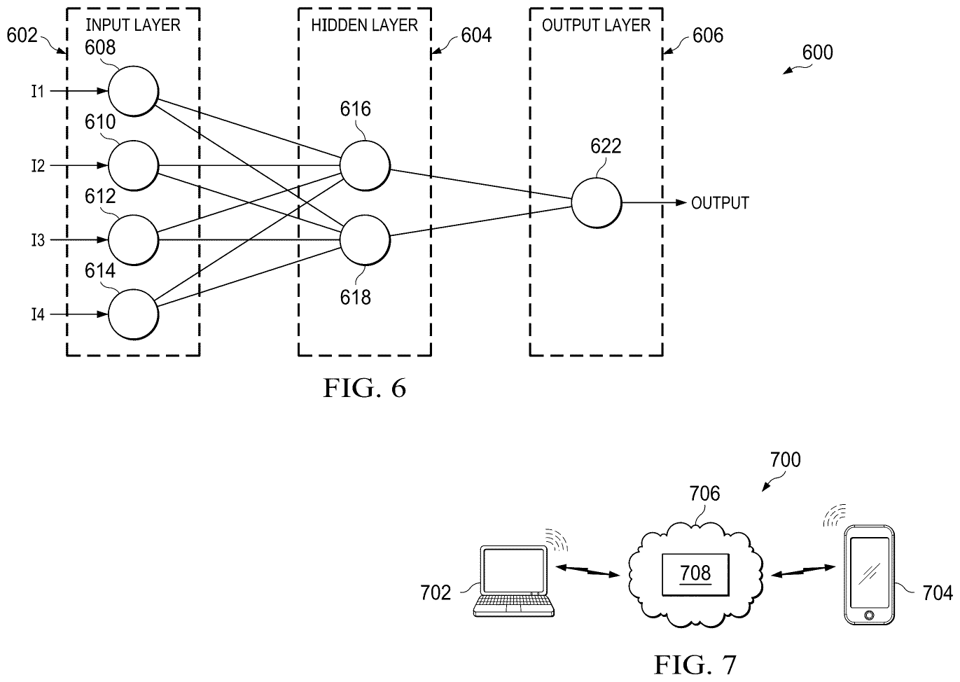

As discussed above, various aspects of the present disclosure may pertain to machine learning. For example, the prediction that needs interpretation in FIG. 2 is generated by a machine learning model. As another example, the autonomous computerized agents may be trained via various machine learning models. As non-limiting examples, the machine learning models may include an artificial neural network. In that regard, FIG. 6 illustrates an example artificial neural network 600. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement a part of the machine learning model of FIG. 2, and such a machine learning model may include as many hidden layers as necessary.

In this example, the artificial neural network 600 receives a set of input values and produces an output value. Each node in the input layer 602 may correspond to a distinct input value. For example, when the artificial neural network 600 is used to implement a machine learning module, each node in the input layer 602 may correspond to a distinct feature, such as the feature obtained in step 230 of FIG. 2.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. When the artificial neural network 600 is used to implement a machine learning module, the output value produced by the artificial neural network 600 may indicate a likelihood of an event (e.g., an occurrence of fraud).

The artificial neural network 600 may be trained by using training data. For example, the training data herein may be the previous transaction information. By providing training data to the artificial neural network 600, the nodes 616-618 in the hidden layer 604 may be trained (adjusted) such that an optimal output (e.g., determining a value for a threshold) is produced in the output layer 606 based on the training data. By continuously providing different sets of training data, and penalizing the artificial neural network 600 when the output of the artificial neural network 600 is incorrect (e.g., when the determined (predicted) likelihood is inconsistent with whether the event actually occurred for the transaction, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the Markov Chain module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the NLM modeling and the machine learning as discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

It should be appreciated that like reference numerals are used to identify like elements illustrated in one or more of the figures, wherein these labeled figures are for purposes of illustrating embodiments of the present disclosure and not for purposes of limiting the same.

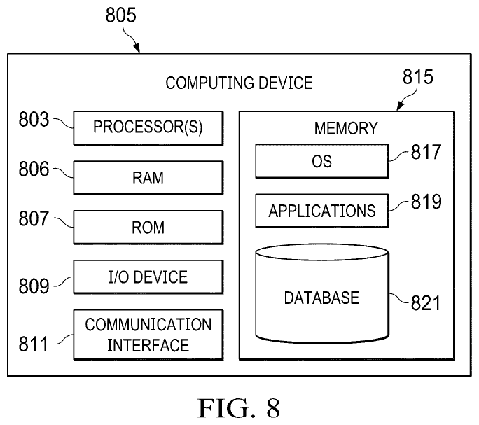

Turning now to FIG. 8, a computing device 805 that may be used with one or more of the computational systems is described. The computing device 805 may be used to implement various computing devices discussed above with reference to FIGS. 1-7. For example, the computing device 805 may be used to implement at least a part of the Markov Chain module 198 of FIG. 1, and/or other components (e.g., the databases 195) of the payment provider server 170. Furthermore, the computing device 805 may be used to implement the user device 110, the merchant server 140, the acquirer host 165, the issuer host 168, or portions thereof, in various embodiments. The computing device 805 may include one or more processors 803 for controlling overall operation of the computing device 805 and its associated components, including RAM 806, ROM 807, input/output device 809, communication interface 811, and/or memory 815. A data bus may interconnect processor(s) 803, RAM 806, ROM 807, memory 815, I/O device 809, and/or communication interface 811. In some embodiments, computing device 805 may represent, be incorporated in, and/or include various devices such as a desktop computer, a computer server, a mobile device, such as a laptop computer, a tablet computer, a smart phone, any other types of mobile computing devices, and the like, and/or any other type of data processing device.

Input/output (I/O) device 809 may include a microphone, keypad, touch screen, and/or stylus motion, gesture, through which a user of the computing device 805 may provide input, and may also include one or more speakers for providing audio output and a video display device for providing textual, audiovisual, and/or graphical output. Software may be stored within memory 815 to provide instructions to processor(s) 803 allowing computing device 805 to perform various actions. For example, memory 815 may store software used by the computing device 805, such as an operating system 817, application programs 819, and/or an associated internal database 821. The various hardware memory units in memory 815 may include volatile and nonvolatile, removable and non-removable media implemented in any method or technology for storage of information such as computer-readable instructions, data structures, program modules, or other data. Memory 815 may include one or more physical persistent memory devices and/or one or more non-persistent memory devices. Memory 815 may include, but is not limited to, random access memory (RAM) 806, read only memory (ROM) 807, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor(s) 803.

Communication interface 811 may include one or more transceivers, digital signal processors, and/or additional circuitry and software for communicating via any network, wired or wireless, using any protocol as described herein.

Processor(s) 803 may include a single central processing unit (CPU) in some embodiments, which may be a single-core or multi-core processor, or it may include multiple CPUs in other embodiments. In some embodiments, the processor(s) 803 may include one or more GPUs, in addition to, or in lieu of, the CPUs. The processor(s) 803 and associated components may allow the computing device 805 to execute a series of computer-readable instructions to perform some or all of the processes described herein. Although not shown in FIG. 8, various elements within memory 815 or other components in computing device 805, may include one or more caches, for example, CPU/GPU caches used by the processor 803, page caches used by the operating system 817, disk caches of a hard drive, and/or database caches used to cache content from database 821. For embodiments including a CPU/GPU cache, the CPU/GPU cache may be used by one or more processors 803 to reduce memory latency and access time. Processor(s) 803 may retrieve data from or write data to the CPU/GPU cache rather than reading/writing to memory 815, which may improve the speed of these operations. In some examples, a database cache may be created in which certain data from a database 821 is cached in a separate smaller database in a memory separate from the database, such as in RAM 806 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 805 are described separately, functionality of the various components may be combined and/or performed by a single component and/or multiple computing devices in communication without departing from the invention.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method. According to the method, a machine learning model is accessed. The machine learning model is trained based on a plurality of data features. Based on the accessing of the machine learning model, an importance of at least a subset of the plurality of data features is estimated. A Markov chain is constructed based on the estimated importance of the subset of the plurality of data features. The estimated importance of each data feature of the subset of the plurality of data features corresponds to a different state in the Markov chain. A prediction generated by the machine learning model is accessed. Via a traversal of the Markov chain, an explanation of the prediction is produced.

Another aspect of the present disclosure involves a method. According to the method, historical performance information of a plurality of autonomous agents configured to handle a plurality of tasks is accessed. The historical performance information indicates, for each autonomous agent, a successful outcome or a failed outcome for each of the tasks handled by the autonomous agent. A Markov chain comprising a plurality of states is constructed based on the autonomous agents. Each autonomous agent corresponds to a different state of the states. For each autonomous agent, a first score and a second score are calculated based on the Markov chain. The first score corresponds to an expected number of transitions from the autonomous agent to other autonomous agents until the successful outcome or the failed outcome is reached, The second score corresponds to a probability of the autonomous agent ultimately achieving the successful outcome. The autonomous agents are evaluated based on the first score and the second score.

Another aspect of the present disclosure involves a system that includes a non-transitory memory and one or more hardware processors coupled to the non-transitory memory and configured to read instructions from the non-transitory memory to cause the system to perform operations comprising: determining, for a plurality of computerized agents, how each computerized agent of the plurality of computerized agents executed a plurality of tasks until either a successful outcome or an unsuccessful outcome has been reached; accessing a Markov chain that is constructed at least in part by mapping the plurality of computerized agents to a plurality of states of the Markov chain; determining, for each computerized agent, a first Markov chain criterion that corresponds to an expected number of transitions from the computerized agent to other computerized agents of the plurality of computerized agents until the successful outcome or the unsuccessful outcome is reached; determining, for each computerized agent, a second Markov chain criterion that corresponds to a probability of the computerized agent ultimately reaching the successful outcome; and evaluating, based at least in part on the first Markov chain criterion and the second Markov chain criterion, a performance of each of the computerized agents.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
accessing a machine learning model that is trained based on a plurality of data features;
estimating, based on the machine learning model, an importance of at least a subset of the plurality of data features;
accessing a Markov chain that is constructed based on the estimated importance of the subset of the plurality of data features, wherein the estimated importance of each data feature of the subset of the plurality of data features corresponds to a different state in the Markov chain;
accessing a prediction generated by the machine learning model; and
producing, via a traversal of the Markov chain, an explanation of the prediction.

2. The method of claim 1, wherein the machine learning model comprises an ensemble model that is trained to perform one or more classification or regression tasks.

3. The method of claim 1, wherein the estimating comprises:
assigning a numeric score to each estimated importance of the subset of the plurality of data features; and
ranking the importance of the subset of the plurality of data features based on their respective assigned numeric scores.

4. The method of claim 1, wherein the Markov chain is constructed at least in part by generating, based on the estimated importance of the subset of the plurality of data features, a transition probability matrix, wherein the transition probability matrix indicates a probability of transitioning between different pairs of the data features in the Markov chain.

5. The method of claim 4, wherein the probability of transitioning is correlated with a likelihood of an influence exerted by one data feature to another data feature in the pair of data features.

6. The method of claim 4, wherein the Markov chain is further constructed by normalizing the estimated importance of the subset of the plurality of data features before the generating the transition probability matrix.

7. The method of claim 1, wherein the traversal of the Markov chain identifies a sequence of data features that contributed to the prediction.

8. The method of claim 1, wherein the explanation comprises a feature importance plot, a decision tree, or an interactive dashboard.

9. A method, comprising:
accessing historical performance information of a plurality of autonomous agents that are configured to handle a plurality of tasks, wherein the historical performance information indicates, for each autonomous agent of the plurality of autonomous agents, a successful outcome or a failed outcome for each task of the plurality of tasks handled by the autonomous agent;
accessing a Markov chain that is constructed based on the plurality of autonomous agents, wherein the Markov chain comprises a plurality of states, and wherein each autonomous agent of the plurality of autonomous agents corresponds to a different state of the plurality of states;
calculating, for each autonomous agent based on the Markov chain:
a first score corresponding to an expected number of transitions from the autonomous agent to other autonomous agents of the plurality of autonomous agents until the successful outcome or the failed outcome is reached; and
a second score corresponding to a probability of the autonomous agent ultimately achieving the successful outcome; and
evaluating the plurality of autonomous agents based on the first score and the second score.

10. The method of claim 9, wherein at least a subset of the plurality of autonomous agents comprise computer chatbots configured for providing customer support or for diagnostics.

11. The method of claim 9, wherein at least a subset of the plurality of autonomous agents comprise one or more Large Language Models (LLMs).

12. The method of claim 11, wherein:
a first autonomous agent of the plurality of autonomous agents comprises a first type of LLM; and
a second autonomous agent of the plurality of autonomous agents comprises a second type of LLM different from the first type.

13. The method of claim 11, wherein:
a first autonomous agent of the plurality of autonomous agents comprises a first type of LLM trained in a first field; and
a second autonomous agent of the plurality of autonomous agents comprises the first type of LLM trained in a second field different from the first field.

14. The method of claim 9, wherein:
the Markov chain comprises a plurality of transient states and a plurality of absorbing states;
the plurality of autonomous agents correspond to the plurality of transient states; and
the successful outcome and the failed outcome correspond to the plurality of absorbing states.

15. The method of claim 9, wherein the Markov chain further comprises a routing mechanism.

16. The method of claim 15, wherein the routing mechanism comprises a classifier or a Large Language Model (LLM).

17. A system, comprising:
one or more processors; and
a non-transitory computer-readable medium having stored thereon instructions that are executable by the one or more processors to cause the system to perform operations comprising:
determining, for a plurality of computerized agents, how each computerized agent of the plurality of computerized agents executed a plurality of tasks until either a successful outcome or an unsuccessful outcome has been reached;
accessing a Markov chain that is constructed at least in part by mapping the plurality of computerized agents to a plurality of states of the Markov chain;
determining, for each computerized agent, a first Markov chain criterion that corresponds to an expected number of transitions from the computerized agent to other computerized agents of the plurality of computerized agents until the successful outcome or the unsuccessful outcome is reached;
determining, for each computerized agent, a second Markov chain criterion that corresponds to a probability of the computerized agent ultimately reaching the successful outcome; and
evaluating, based at least in part on the first Markov chain criterion and the second Markov chain criterion, a performance of each of the computerized agents.

18. The system of claim 17, wherein the plurality of computerized agents comprise computerized agents associated with different types of Large Language Models (LLMs).

19. The system of claim 17, wherein the Markov chain further comprises a Large Language Model (LLM)-based routing mechanism.

20. The system of claim 17, wherein:
the plurality of states of the Markov chain comprises a plurality of transient states and a plurality of absorbing states;
the plurality of computerized agents correspond to the plurality of transient states; and
the successful outcome and the unsuccessful outcome correspond to the plurality of absorbing states.
